(19) United States
(12) Patent Application Publication
(10) Pub. No.: US 2012/0290733 A1
(43) Pub. Date: Nov. 15, 2012

(54) METHOD OF ESTABLISHING COMMUNICATION IN A COMMUNICATIONS NETWORK

(76) Inventors: Julian Harding, Coventry (GB); Ian Gordon Elz, Coventry (GB); Jonathan Gray, Coventry (GB); Nigel Weinronk, Coventry (GB)

(21) Appl. No.: 13/522,091

(22) PCT Filed: Apr. 19, 2010
(86) PCT No.: PCT/EP2010/055124

§ 371 Date: Jul. 13, 2012

Related U.S. Application Data
(60) Provisional application No. 61/294,976, filed on Jan. 14, 2010.

(51) Int. Cl. G06F 15/16

(52) U.S. Cl. 709/228

(57) ABSTRACT

The invention provides a method of establishing communication in a communications network in which a communication initiation request including service suppression information indicating that the whole or part of a communication service associated with the communication should be suppressed is generated and sent to initiate communication. When the communication initiation request is received (50) it is determined (52) whether it includes service suppression information indicating that the whole or part of a communication service associated with the communication should be suppressed. If so, the whole or part of a communication service corresponding to the service suppression information is suppressed (54).

### TECHNICAL FIELD

The invention relates to a method of establishing communication in a communication network. In particular, the invention may be applicable to the initiation of a communication session within a communication network using an IP multimedia subsystem (IMS).

### BACKGROUND

Generally in modern communication networks, before a communication such as a voice call or a data exchange between two users can occur, signaling communication is carried out over a signaling network to establish the parameters for the communication session.

An example of one such signaling network is IP multimedia subsystem (IMS) which is used for communication systems. The IMS uses the Session Initiation Protocol (SIP) as a signaling protocol. Standard IMS routing principles are specified in 3GPP TS 24.229 “IP multimedia call control protocol based on Session Initiation Protocol (SIP) and Session Description Protocol (SDP)”; Stage 3 (Release 8).

A typical communication session in the communication network is initiated by an originating user sending a SIP request message in the IMS. The SIP request message is routed in accordance with the IMS routing principles identified above to set up the communication session. As part of this communication session initiation process, originating services, such as a “call back on busy subscriber” service, may be set up for an originating user, and terminating services, such as voice-mail or call re-direct, may be set up for the terminating user. These originating services and terminating services are generally hosted on, and executed on, respective application servers within the IP multimedia subsystem (IMS).

In some situations a communication session is initiated not by a user but by a network node in a 3rd party call control (3PCC) process. A 3PCC process is used for example in situations where a service running on an application server initiates a communication session.

Call completion is one example where a 3PCC process can be used to complete a call when a previous attempt by an originating user to set up a communication session has failed because the called user is unavailable. A call completion service for the originating user may subsequently try to complete the call by initiating a communication session between the served user of the call completion service (i.e. the originating user) and the called user. In order to initiate the new communication session, the call completion service firsts sends a call request message to its served user and, once the served user call leg is established, the call completion service sends a call request message to the called user in order to complete the initiation of the communication session.

An existing solution for communication completion from 3GPP is set out in 3GPP TS 24.642 “Completion of Communications to Busy Subscriber (CCBS); Completion of Communications by No Reply (CCNR) using IP Multimedia (IM) Core Network (CN) subsystem”; (Release 8).

During a 3PCC process, the communication request messages sent from the call completion service to the served user and then the communication request messages sent from the call completion service to the called user are routed through the IMS network according to the standard IMS routing principles. However, these routing principles can result in originating and terminating services being unnecessarily executed for the served user and can result in unnecessary routing of call request messages back to the application server that originated the communication request messages. These wrongly invoked services can interfere with the correct operation of the communication session. Moreover, other services may prevent this call from working or prevent other calls from being made or received.

The invention seeks to provide an improved method of establishing communication in a communication system.

### SUMMARY

In accordance with a first aspect of the invention there is provided a method, in a first network node, of establishing communication in a communications network. In a first step a communication initiation request including service suppression information indicating that the whole or part of a communication service associated with the communication should be suppressed is generated. In a second step the communication initiation request is sent to establish communication.

In accordance with a second aspect of the invention there is provided a method in a second network node of a communications network. In a first step a communication initiation request is received. In a second step, it is determined whether the communication initiation request includes service suppression information indicating that the whole or part of a communication service associated with the communication should be suppressed. In a third step, the whole or part of a communication service corresponding to the service suppression information is suppressed when the communication initiation request includes service suppression information.

In accordance with a third aspect of the invention there is provided a network node for a communications network. The network node comprises a communication initiation service element, for generating a communication initiation request, the communication initiation request including service suppression information indicating that the whole or part of a communication service associated with the communication should be suppressed. The network node also comprises an interface for sending the communication initiation request to establish communication.

In accordance with a fourth aspect of the invention there is provided a network node for a communications network. The network node comprises a communication service trigger element arranged to receive a communication initiation request and to determine whether the received communication initiation request includes service suppression information indicating that the whole or part of a communication service associated with the communication should be suppressed, and for suppressing the whole or part of a communication service corresponding to the service suppression information when the communication initiation request includes service suppression information.

In embodiments of the invention the application server generating an initial SIP request message adds some additional information to indicate that IMS Initial Filter Criteria (IFC) triggering should be suppressed for the current request at either the originating side, the terminating side, or at both sides, as the request is routed forward in the network. In some embodiments of the invention, the network may be a IP multimedia subsystem (IMS). Embodiments may be used in signaling networks for both wired and wireless communication systems.

With the addition of this extra information to the SIP request, it becomes possible to modify the originating and terminating IFC triggers to prevent requests containing the above information from being directed back to the application server from which it originated, and if required, to suppress the triggering of originating and terminating services on other application servers.

In typical embodiments this invention relates to suppression of Initial Filter Criteria (IFC) triggering in an IMS network. However, in some embodiments information may be added to a SIP request to suppress individual features on another AS rather than suppressing the AS triggering completely. (i.e. the IFC triggering is not suppressed, the SIP request reaches another application server, then the other application server takes action based on the suppression information added to the SIP request).

In accordance with a fifth aspect, the invention relates to a method of establishing communication in a communications network comprising the step of generating a SIP request by an application server. To this SIP request information is added indicating that a feature of a call should be suppressed. When the request is received by a second application server an individual feature is suppressed on the second application server based on the information added to the SIP request.

In some embodiments a feature that would normally trigger an application server for a given request, suppresses the triggering if the trigger suppression information is present in the request.

Further features of the present invention are as claimed in the dependent claims.

### BRIEF DESCRIPTION OF THE DRAWINGS

The invention will now be described by way of example with reference to the accompanying drawings:

FIG. 1 is a block diagram of the main components of a call session signalling system;

FIG. 2 shows message flows during a standard communication system call session initiation in the system shown in FIG. 1;

FIG. 3 shows message flows during the establishment of a call leg towards the served user in the system shown in FIG. 1;

FIG. 4 shows message flows during the establishment of a call leg towards the called user in the system shown in FIG. 1;

FIG. 5 shows a block diagram of the main components of a communications network in accordance with a first exemplary embodiment;

FIG. 6 shows a block diagram of the main components of an exemplary network node of the call session signalling system of FIG. 5 in accordance with a first exemplary embodiment;

FIG. 7 is a flow chart showing steps in a method of initiating communication in the network node shown in FIG. 6;

FIG. 8 shows a block diagram of the main components of an exemplary network node of the call session signalling system of FIG. 5 in accordance with a first exemplary embodiment;

FIG. 9 is a flow chart showing steps in a method of initiating communication in a network node shown in FIG. 8;

FIG. 10 shows message flows during the establishment of a call leg towards the served user in the system shown in FIG. 5;

FIG. 11 shows message flows during the establishment of a call leg towards the served user in the system shown in FIG. 5;

FIG. 12 shows a block diagram of the main components of network nodes of the call session signalling system of FIG. 5 in accordance with a second embodiment; and

FIG. 13 is a flow chart showing steps in a method of initiating communication in a network node shown in FIG. 12.

### DETAILED DESCRIPTION

An exemplary embodiment relating to call completion in an IP multimedia Subsystem (IMS) will now be described.

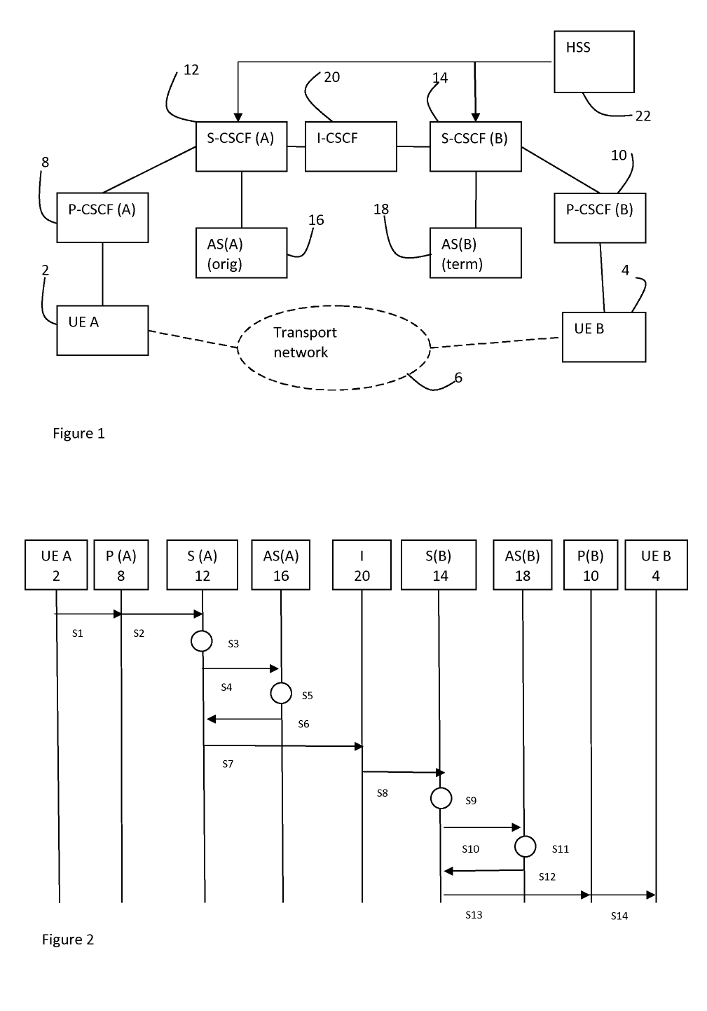

First, the standard IMS routing principles used during initiation of a communication session and the problems arising when these routing principles are used during communication sessions initiated at a network node, for example at an application server for a call completion service, will be described with reference to FIGS. 1-4.

FIG. 1 is a block diagram of the main components of a call session signalling system. In the described arrangement, the call session signalling system is an IP multimedia Subsystem (IMS). The IP multimedia Subsystem (IMS) uses Session initiation Protocol (SIP).

The IP multimedia Subsystem (IMS) is used to set up a communication session between the user terminal (UE-A) 2 of a first user and the user terminal (UE-B) 4 of a second user using the transport network 6. The communication session connection between user terminal UE-A 2 and user terminal UE-B 4 via the transport network 6 is shown in dashed lines since the actual communication session is not relevant to the present description.

Each of user terminals UE-A 2 and UE-B 4 are coupled to respective Proxy-Call Session Control Functions P-CSCF(A) 8 and P-CSCF(B) 10 through which the user terminals UE-A 2 and UE-B 4 access the IP multimedia Subsystem (IMS). In turn, each of the Proxy-Call Session Control Functions P- CSCF(A) 8 and P-CSCF(B) 10 are connected to respective Serving-Call Session Control Functions S-CSCF 12 and S-CSCF 14. The Serving-Call Session Control Functions S-CSCF 12 and S-CSCF 14 perform session control for communication sessions involving the respective user terminals UE-A 2 and UE-B 4, and determine the appropriate application server to provide services, including originating services and terminating services, for the respective user terminals UE-A 2 and UE-B 4.

Application servers AS(A) 16 and AS(B) 18 are provided and are coupled to respective Serving-Call Session Control Functions S-CSCF 12 and S-CSCF 14. The application servers host and execute services for communication system users. Typically an application server may host originating services for a communication system user that are executed when the associated user is originating user, i.e. is the user initiating the communication session. The application server may host terminating services for a communication system user that are executed when the associated user is a terminating user i.e. is the user to which the communication session is directed.

In the arrangement shown in FIG. 1 application server AS(A) 16 is coupled to Serving-Call Session Control Function S-CSCF 12 and provides services for user terminal UE-A 2 when requested by the Serving-Call Session Control Function S-CSCF 12. In the standard method for communication session initiation which will be described with reference to FIG. 2 the user terminal UE-A 2 is the originating user terminal, and therefore the application server AS(A) 16 will execute originating services for user terminal UE-A 2, as denoted by the (orig) designation in FIG. 1.

In the arrangement shown in FIG. 1 AS(B) 18 is coupled to Serving-Call Session Control Function S-CSCF 14 to provide services for user terminal UE-B 4, when requested to by the Serving-Call Session Control Function S-CSCF 14. In the standard method for communication session initiation which will be described with reference to FIG. 2 the user terminal UE-B 4 is the terminating user terminal, and therefore the application server AS(B) 18 will execute terminating services for the user terminal UE-B 4 as denoted by the (term) designation in FIG. 1.

The Serving-Call Session Control Function S-CSCF 12 and Serving-Call Session Control Function S-CSCF 14 are both coupled to an Interrogating- Call Session Control Function I-CSCF 20. The Interrogating -Call Session Control Function I-CSCF 20 has access to location information of the Serving-Call Session Control Function S-CSCF for each user and is used to route messages to the correct Serving-Call Session Control Function S-CSCF for a user within the IMS.

Finally, a Home Subscriber Server HSS 22 is provided to support the IMS network entities. One function of the Home Subscriber Server HSS 22 is to supply Initial Filter Criteria IFC (not shown) to the Serving-Call Session Control Function S-CSCF 12 and Serving-Call Session Control Function S-CSCF 14. The Serving-Call Session Control Function S-CSCF 12 and Serving-Call Session Control Function S-CSCF 14 use the Initial Filter Criteria (IFC) to determine what action to be taken when SIP messages are received, as will be explained in more detail below.

It will be understood by a skilled person that the connections between the different network entities in FIG. 1 are intended to show logical connections and the physical connections between the network entities may be direct or indirect.

A standard call session initiation in the system shown in FIG. 1 will now be explained in the context of a call that a first user, Bob, wishes to make to a second user, Alice.

In order to initiate this communication session, Bob's user terminal UE-A 2 sends an initial SIP request to Alice's terminal UE-B 4. The initial SIP request is an INVITE request message having the following format:
INVITE “Alice”<sip:alice@biloxi.com>; SIP/2.0

### Where:

INVITE is the SIP message type used to initiate the communication sessions;
sip:alice@biloxi.com is the SIP address of terminal UE-B 4, that enables the IMS network to locate Alice; and
SIP/2.0: identifies the message as a version 2.0 Session Initiation Protocol message

The communication session is initiated by Bob's user terminal UE-A 2 sending this initial SIP request to Alice's user terminal UE-B 4 through the IMS. The routing of the initial SIP request through the IMS must take into account that Bob's user terminal UE-A 2 does not necessarily know where to find Alice's user terminal UE-B 4. In addition, originating services must be executed for this communication session for the originating user, Bob, and terminating services must be executed for this communication session for the terminating user, Alice.

FIG. 2 shows message flows during a standard method of call session initiation in the system shown in FIG. 1 as follows:
S1. Bob's user terminal UE-A 2 initiates a communication session by sending an INVITE message to the Proxy-Call Session Control Function P-CSCF 8 associated with Bob's user terminal UE-A 2 to access the IP Multimedia sub-system
S2. The INVITE message arrives at Proxy-Call Session Control Function P-CSCF 8 and is routed as an originating message to the Serving-Call Session Control Function S-CSCF 12 associated with Bob's user terminal UE-A 2.
S3. The INVITE message received at Serving-Call Session Control Function S-SCSF 12 is compared with Initial Filter Criteria (IFC) data relating to the first user, Bob, which the Serving-Call Session Control Function S-CSCF 12 has received from the Home Subscriber Server HSS 22. An Initial Filter Criteria (IFC) trigger for execution of originating services is triggered by the received INVITE message, which identifies the application server AS(A) 16 providing originating services for Bob.
S4. In response to the Initial Filter Criteria (IFC) triggering of originating services, the Serving-Call Session Control Function S-CSCF 12 sends the INVITE message to the identified application server AS(A) 16.
S5. Application server AS(A) 16 executes the originating services for Bob.
S6. Once originating services have been executed, the application server AS(A) 16 sends the INVITE message back to the Serving-Call Session Control Function S-CSCF 12.
S7. The INVITE message is now routed onwards towards Alice. Since the Serving-Call Session Control Function S-CSCF 12 does not know which Serving-Call Session Control Function S-CSCF 14 Alice's user terminal UE-B 4 is registered with, the INVITE message is routed to the Interrogating-Call Session Control Function I-CSCF 20.
S8. The Interrogating-Call Session Control Function I-CSCF 20 routes the INVITE message as a terminating message to the Serving-Call Session Control Function S-CSCF 14 that Alice's user terminal UE-B 4 is registered with.
S9. The INVITE message received at the Serving-Call Session Control Function S-SCSF 14 is compared with triggers governed by the Initial Filter Criteria (IFC) data relating to the second user, Alice, which the Serving-Call Session Control Function S-CSCF 14 has received from the Home Subscriber Server HSS 22. An Initial Filter Criteria (IFC) trigger for execution of terminating services is triggered by the received INVITE message, which identifies the application server AS(B) 18 providing terminating services for Alice.
S10. In response to the Initial Filter Criteria (IFC) triggering of terminating services, the Serving-Call Session Control Function S-CSCF 14 sends the INVITE message to the identified application server AS(B) 18.
S11. Application server AS(B) 18 runs the terminating services for Alice.
S12. Once terminating services have run, the application server AS(B) 18 sends the INVITE message back to the Serving-Call Session Control Function S-CSCF 14 that Alice's user terminal UE-B 4 is registered with.
S13. S-CSCF 14 then sends the INVITE message to the Proxy-Call Session Control Function P-CSCF 10 that Alice's user terminal UE-B 4 is registered with
S14. The Proxy-Call Session Control Function P-CSCF 10 sends the INVITE message on to Alice's user terminal UE-B 4

The triggering of services using initial filter criteria (IFC) carried out in steps S3 and S9 will now be explained in more detail.

As indicated above, Serving-Call Session Control Functions S-CSCF 12 and 14 receive from the Home Subscriber Server HSS 22 initial filter criteria (IFC) for users registered with the respective Serving-Call Session Control Function S-CSCF.

The initial filter criteria (IFC) identify elements in a received message for that user to which the Serving-Call Session Control Function S-CSCF should respond, and specifies the Serving-Call Session Control Function S-CSCF response to be triggered by that identification. Typically there will be a number of Initial filter criteria (IFC), which may be different depending on whether the received message is being routed as an originating message or a terminating message.

When an originating INVITE request message is received at a Serving-Call Session Control Function S-CSCF a standard initial filter criteria for executing originating services is triggered, and the originating message is routed to the identified application server to execute the originating services.

When a terminating INVITE request message is received at a Serving-Call Session Control Function S-CSCF, standard initial filter criteria for executing terminating services are triggered, and the terminating message is routed to the identified application server to execute the terminating services.

The execution of originating services for Bob, in step S5, occurs in response to the Initial Filter Criteria (IFC) originating services trigger for Bob being satisfied by the receipt of an originating routed INVITE request message in step S3. The execution of terminating services for Alice, in step S11, occurs in response to the Initial Filter Criteria (IFC) terminating services trigger for Alice being satisfied by the receipt of a terminating routed INVITE request message in step S9.

This standard communication initiation method described above with reference to FIG. 2 initiates a communication between Bob's user terminal UE-A 2 and Alice's user terminal UE-B 4 while ensuring first that the originating services relevant to the originating user Bob are executed and secondly that the terminating services relevant to the called user Alice are executed.

Problems can arise when a communication session is initiated at a network node such as an application server. An example of a situation in which communication session is initiated at an application server may occur, when Bob's originating services include a call completion service. When a previous session initiation request has failed, for example because Alice was busy, the call completion service for Bob on application server AS(A) 16 may now attempt to complete the call to Alice for Bob.

As a first step a call leg is set up towards Bob as the user being served by the call completion service. As will be known to a skilled person, for the call leg set up towards Bob, the initial SIP request is an INVITE request message towards Bob which may have the following format:
INVITE “Bob”<sip:Bob@biloxi.com>; m=BS; SIP/2.0

### Where:

INVITE is the SIP message type used to initiate communications sessions;
sip:Bob@biloxi.com is the SIP address of UE-B 2, that enables the IMS network to locate Bob;
m=BS indicates that this is a busy subscriber call completion; and
SIP/2.0: identifies the message as a version 2.0 Session Initiation Protocol message

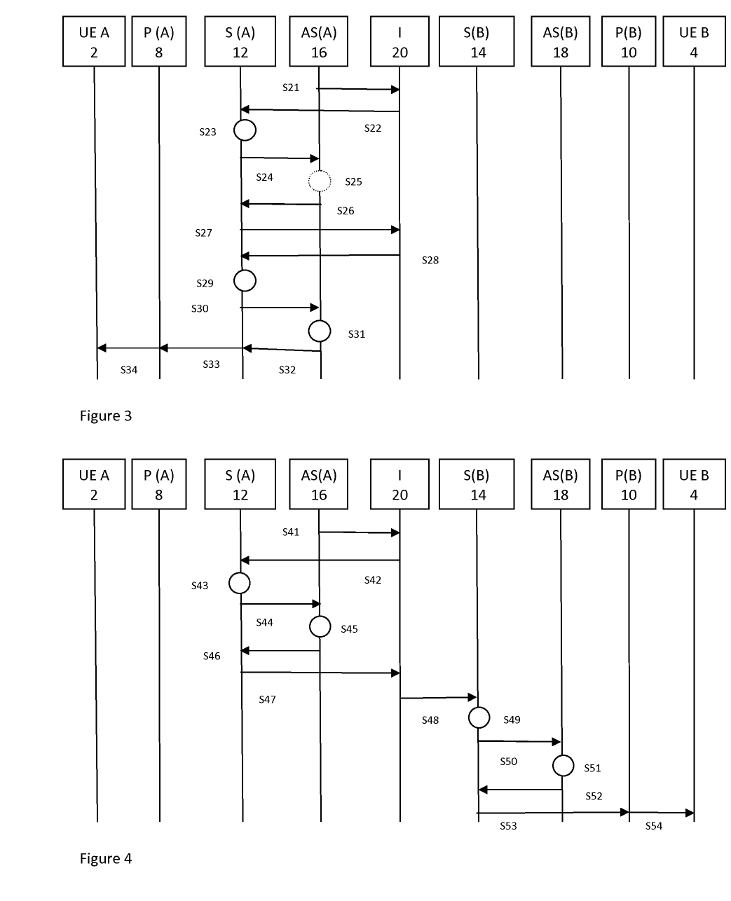

FIG. 3 shows message flows during the set up of a call leg towards the served user Bob during execution of a call completion service in the system shown in FIG. 1.
s21. For the call leg towards the served user Bob, the call completion service on application server AS(A) 16 associated with served user Bob generates an INVITE message, as indicated above, to Bob. The INVITE message is sent towards the user terminal UE-A 2 for served user, Bob. This is achieved by sending the INVITE message to the Interrogating-Call Session Control Function I-CSCF 20.
s22. The Interrogating-Call Session Control Function I-CSCF 20 performs originating routing and sends the INVITE message as an originating message to Serving-Call Session Control Function S-CSCF 12 associated with Bob's user terminal UE-A 2.
s23. The INVITE message received at Serving-Call Session Control Function S-SCSF 12 is compared with Initial Filter Criteria (IFC) data relating to the first user, Bob, which the Serving-Call Session Control Function S-CSCF 12 has received from the Home Subscriber Server HSS 22. An IFC trigger for execution of originating services is satisfied by the received INVITE message, which identifies the application server AS(A) 16 providing originating services for Bob.
s24. In response to the Initial Filter Criteria (IFC) triggering of originating services, the Serving-Call Session Control Function S-CSCF 12 sends the INVITE message to the identified application server AS(A) 16.
s25. Application server AS(A) 16 executes the originating services for Bob.
s26. Once originating services have been executed, the application server AS(A) 16 sends the INVITE message back to the Serving-Call Session Control Function S-CSCF 12.
s27. The INVITE message is now routed onwards. The Serving-Call Session Control Function S-CSCF 12 routes the INVITE message to the Interrogating-Call Session Control Function I-CSCF 20.
s28. The Interrogating-Call Session Control Function I-CSCF 20 now performs terminating routing and sends the INVITE message as a terminating message to the Serving-Call Session Control Function S-CSCF 12 with which Bob's user terminal UE-A 2 is registered.
s29. The INVITE message received at Serving-Call Session Control Function S-SCSF 12 with terminating routing is compared with Initial Filter Criteria (IFC) data relating to the served user, Bob, which the Serving-Call Session Control Function S-CSCF 12 has received from the Home Subscriber Server HSS 22. An IFC trigger for execution of terminating services is satisfied by the received INVITE message, which identifies the application server AS(A) 16 providing terminating services for Bob.
s30. In response to the Initial Filter Criteria (IFC) triggering of terminating services, the Serving-Call Session Control Function S-CSCF 12 sends the INVITE message to the identified application server AS(A) 16.
s31. Application server AS(A) 16 executes the terminating services for Bob.
s32. Once terminating services have been executed, the application server AS(A) 16 sends the INVITE message back to the Serving-Call Session Control Function S-CSCF 12.
s33. Serving-Call Session Control Function S-CSCF 12 then sends the INVITE message to the Proxy-Call Session Control Function P-CSCF 8 with which Bob's user terminal UE-A 2 is registered.
s34. The Proxy-Call Session Control Function P-CSCF 8 sends the INVITE message on to Bob's user terminal UE-A 2

Once the call leg is set up towards Bob as the user being served by the call completion service, the call leg to the called user Alice is set up by the call completion service at the application server AS(A)16. Again, as will be known to a skilled person, the initial SIP request is an INVITE request message sent towards Alice having the following format:
INVITE “Alice”<sip:Alice@biloxi.com>; m=BS; SIP/2.0

### Where:

INVITE is the SIP message type used to initiate communications sessions;
sip:Alice@biloxi.com is the SIP address of UE-B 4, that enables the IMS network to locate Alice;
m=BS indicates that this is a busy subscriber call completion; and
SIP/2.0: identifies the message as a version 2.0 Session Initiation Protocol message

FIG. 4 shows message flows during the set up of a call leg towards the called user Alice during execution of a call completion service in the system shown in FIG. 1.
s41. For the call leg towards the called user Alice, the call completion service on served user Bob's application server AS(A) 16 generates an INVITE message, as indicated above, to Alice. The INVITE message is sent towards the user terminal UE-B 4 for the called user, Alice. This is achieved by sending the INVITE message to the Interrogating-Call Session Control Function I-CSCF 20.
s42. The Interrogating-Call Session Control Function I-CSCF 20 performs originating routing and sends the INVITE message to Serving-Call Session Control Function S-CSCF 12 associated with Bob's user terminal UE-A 2
s43. The INVITE message received at Serving-Call Session Control Function S-SCSF 12 is compared with Initial Filter Criteria (IFC) data relating to the served user, Bob, which the Serving-Call Session Control Function S-CSCF 12 has received from the Home Subscriber Server HSS 22. An Initial Filter Criteria (IFC) trigger for execution of originating services is satisfied by the received INVITE message, which identifies the application server AS(A) 16 providing originating services for Bob.
s44. In response to the Initial Filter Criteria (IFC) triggering of originating services, the Serving-Call Session Control Function S-CSCF 12 sends the INVITE message to the identified application server AS(A) 16.
s45. Application server AS(A) 16 executes the originating services for Bob.
s46. Once originating services have been executed, the application server AS(A) 16 sends the INVITE message back to the Serving-Call Session Control Function S-CSCF 12.
s47. The INVITE message is routed onwards. The Serving-Call Session Control Function S-CSCF 12 routes the INVITE message to the Interrogating-Call Session Control Function I-CSCF 20.
s48. The Interrogating-Call Session Control Function I-CSCF 20 now performs terminating routing and sends the INVITE message to the Serving-Call Session Control Function S-CSCF 14 with which Alice's user terminal UE-B 4 is registered.
s49. The INVITE message received at Serving-Call Session Control Function S-SCSF 14 with terminating routing is compared with Initial Filter Criteria (IFC) data relating to the called user, Alice, which the Serving-Call Session Control Function S-CSCF 14 has received from the Home Subscriber Server HSS 22. An IFC trigger for execution of terminating services is satisfied by the received INVITE message, which identifies the application server AS(B) 18 providing terminating services for Alice.
s50. In response to the Initial Filter Criteria (IFC) triggering of terminating services, the Serving-Call Session Control Function S-CSCF 14 sends the INVITE message to the identified application server AS(B) 18.
s51. Application server AS(B) 18 executes the terminating service for Alice.
s52. Once terminating services have been executed, the application server AS(B) 18 sends the INVITE message back to the Serving-Call Session Control Function S-CSCF 14
s53. Serving-Call Session Control Function S-CSCF 14 then sends the INVITE message to the Proxy-Call Session Control Function P-CSCF 10 with which Alice's user terminal UE-B 4 is registered.
s54. The Proxy-Call Session Control Function P-CSCF 10 sends the INVITE message on to Alice's user terminal UE-B 4.

The call completion service for Bob has established a call leg towards the served user, Bob, and towards the called user, Alice, and the call can now be completed.

For the call resulting from the execution of the call completion service, the originating services and terminating services for Bob and Alice should be as shown in FIG. 1, namely originating services have been executed for Bob on application server AS(A) 16 and that terminating services have been executed for Alice on application server AS(B) 18.

However, the call completion service on Bob's application server AS(A) 16 initiates the call completion service. Therefore originating services for Bob are already executed, or the execution of the originating services for Bob may be arranged by the call completion service. During the set up of the call legs towards the served user Bob and towards the called user Alice it can be seen that the routing of the INVITE message according to standard principles results in: the originating services for Bob being executed on application server AS(A) 16 in step s25; the terminating services for Bob being executed on application server AS(A) 16 in step s31; and the originating services for Bob being executed on application server AS(A) 16 in step s45.

The multiple executions of originating services for the served user Bob is unnecessary. In addition, the execution of terminating services for the served user Bob is wrong for a communication session in which Bob will be the originating user. The repeated execution of services and the repeated looping back of the INVITE request message to the application servers is wasteful of resources and may result in the wrong services being made available, or the correct services being unable to work.

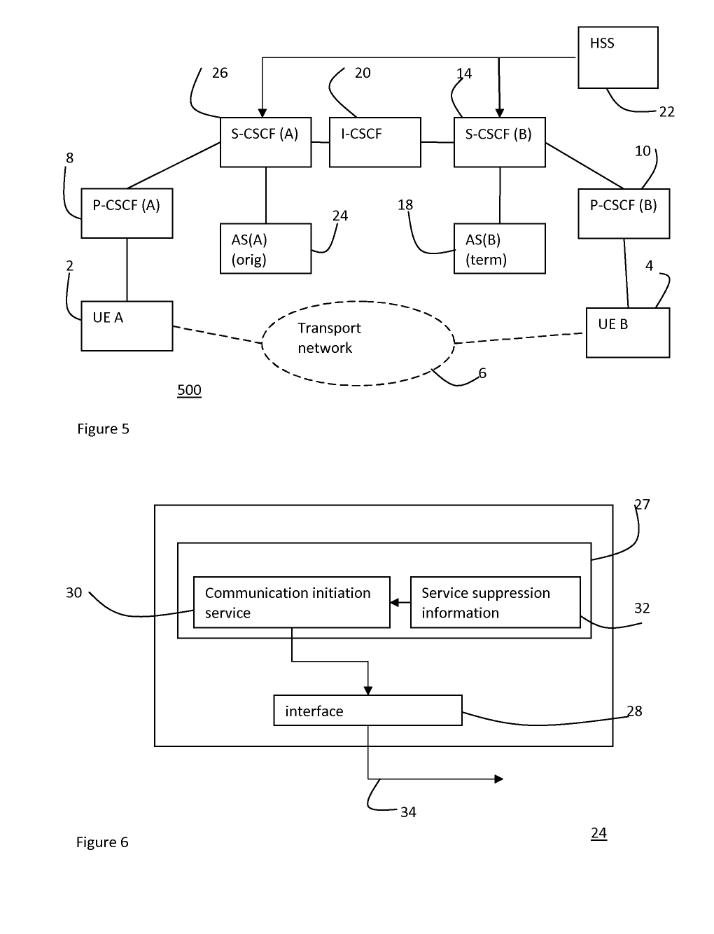

FIG. 5 shows a block diagram of the main components of a call session signalling system in a communications network 500 in accordance with a first exemplary embodiment.

In the illustrated exemplary embodiment, the call session signalling system in the communications network 500 is an IP multimedia subsystem (IMS) using Session initiation Protocol (SIP). However, it will be understood by a skilled person that embodiments may be implemented in other systems.

Components of the IMS of the exemplary embodiment shown in FIG. 5 are similar to and operate in the same manner as corresponding components of the call session signalling system shown in FIG. 1, and have been given the same reference numerals.

Thus, the IMS shown in FIG. 5 is used to set up a communication session between the user terminal UE-A 2 of a first user and the user terminal UE-B 4 of a second user using the transport network 6. The communication session connection between user terminals UE-A 2 and UE-B 4 via the transport network 6 is shown in dashed lines since the actual communication session is not relevant to the present description.

Each of user terminals UE-A 2 and UE-B 4 are coupled to respective proxy-Call Session Control Functions P-CSCF(A) 8 and P-CSCF(B) 10 through which the user terminals UE-A 2 and the UE-B 4 access the IP multimedia subsystem (IMS). In turn, each of the Proxy-Call Session Control Functions P- CSCF(A) 8 and P-CSCF(B) 10 are connected to respective Serving-Call Session Control Functions S-CSCF 12 and S-CSCF 14. The Serving-Call Session Control Functions S-CSCF 12 and S-CSCF 14 perform session control for communication sessions involving the respective user terminals UE-A 2 and UE-B 4, and determine the appropriate application server to provide services for the respective user terminals UE-A 2 and UE-B 4.

Application servers AS(A) 24 and AS(B) 18 are provided and are coupled to respective Serving-Call Session Control Functions S-CSCF 26 and S-CSCF 14. The application servers host and execute services for communication system users. Typically the application server may host originating services for a communication system user, that are executed when the associated user is originating user, i.e. is initiating the communication session, and terminating services that are executed when the associated user is a terminating user i.e. the user to which the communication session is directed.

In the arrangement shown in FIG. 5 application server AS(A) 24 is coupled to Serving-Call Session Control Function S-CSCF 26 to provide services for user terminal UE-A 2. In the arrangement shown in FIG. 5 application server AS(B) 18 is coupled to S-CSCF 14 to provide services for user terminal UE-B 4.

The Serving-Call Session Control Functions S-CSCF 26 and S-CSCF 14 are both coupled to an Interrogating- Call Session Control Function I-CSCF 20. The Interrogating -Call Session Control Function I-CSCF 20 has access to location information of the Serving-Call Session Control Function S-CSCF for each user and is used to route messages to the correct Serving-Call Session Control Function S-CSCF for a user within the IP multimedia subsystem (IMS).

Finally, a Home Subscriber Server HSS 22 is provided to support the IMS network entities. One function of the Home Subscriber Server HSS 22 is to supply Initial Filter Criteria IFC (not shown) to the Serving-Call Session Control Functions S-CSCF 26 and S-CSCF 14. The Serving-Call Session Control Functions S-CSCF 26 and S-CSCF 14 use the Initial Filter Criteria (IFC) to determine what action is to be taken when SIP messages are received.

It will be understood by a skilled person that the connections between the different entities of the communications network 500 in FIG. 5 are intended to show logical connections and the physical connections between the network entities may be direct or indirect.

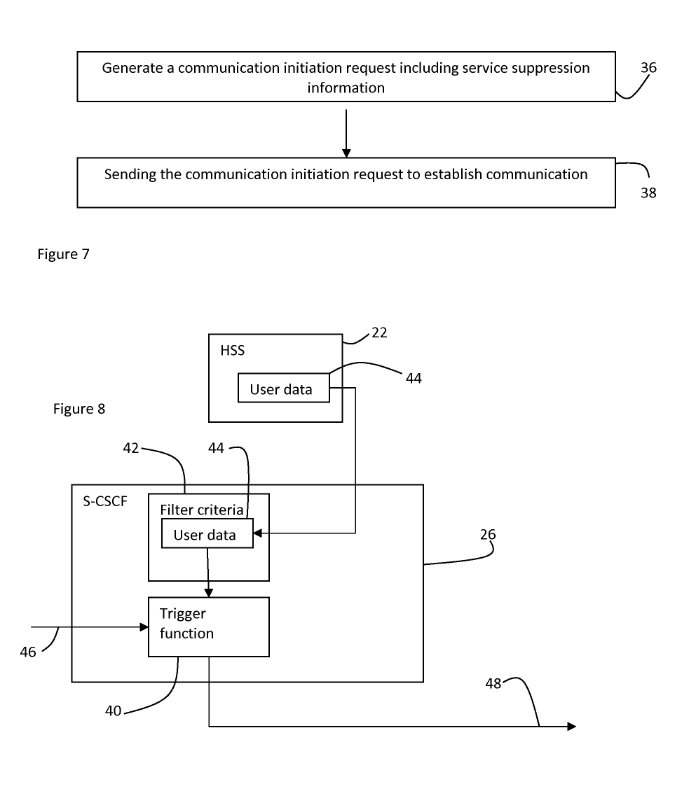

FIG. 6 shows a block diagram of the main components of the application server 24 of FIG. 5 implementing a first embodiment of the invention, and FIG. 7 is a flow chart showing steps in a method of initiating communication in the application server 24 shown in FIG. 6.

The application server 24 has application logic 27 for controlling and running a plurality of services, and an interface 28 through which messages can be received from or sent to other network nodes. In the network of the present invention, the interface 28 is a SIP interface.

A communication initiation service 30 is provided. The communication initiation service 30 may be any service that initiates a communication within the exemplary network. For example, in the exemplary embodiment the communication initiation service 30 is a call completion service. The communication initiation service is coupled to access service suppression information 32. The service suppression information may be stored within a data storage area for the communication initiation service in some embodiments (not shown explicitly).

In order to initiate communication, the communication initiation service 30 creates a communication initiation message 34 including service suppression information 32, as set out in step 36 of FIG. 7. The communication initiation service 30 then sends the communication initiation request 34 through the interface 34 to establish communication, as shown in step 38 of FIG. 38.

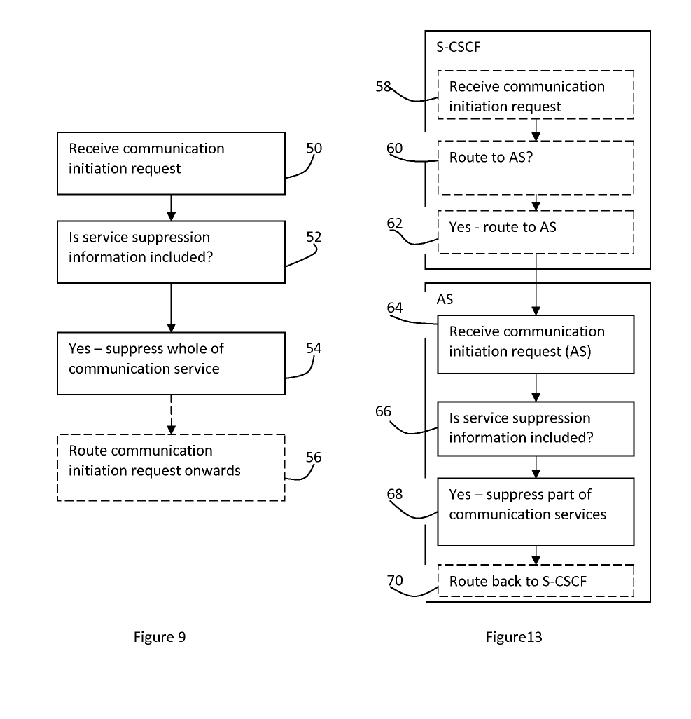

FIG. 8 shows a block diagram of the main components of a network node of the call session signalling system of FIG. 5 in accordance with an embodiment. FIG. 9 is a flow chart showing steps in a method of initiating communication in a network node shown in FIG. 8.

In the exemplary embodiment, the network node shown in FIG. 8 is a Serving-Call Session Control Function. FIG. 8 shows the Serving-Call Session Control Function S-CSCF 26 of FIG. 5 operating in a first operating mode in accordance with one embodiment, and only components relevant to the operation in accordance with the first operating mode have been shown.

It will be appreciated that the exemplary embodiment described with reference to the exemplary Serving-Call Session Control Function S-CSCF 26 may be implemented in any network node, and in particular may be implemented in any Serving-Call Session Control Function S-CSCF 26.

The Serving-Call Session Control Function S-CSCF 26 has a trigger function 40 coupled to a filter criteria store 42 in which user suppression condition data 44 is stored. The user suppression condition data 44 stored in the filter criteria 42 of the Serving-Call Session Control Function S-CSCF 26 has been downloaded from the Home Subscriber Server HSS 22. In the exemplary embodiment the user suppression condition data 44 are filter criteria.

A method of initiating communication in the network node shown in FIG. 8 in accordance with an exemplary embodiment is shown in FIG. 9.

In step 50 a communication initiation message is received, and a determination is made whether the received communication initiation message includes service suppression information in step 52.

If the determination in step 52 is positive, and service suppression information is included in the communication initiation request, the communication service is suppressed, step 54.

In the exemplary arrangement shown in FIG. 8, the Serving-Call Session Control Function S-CSCF 26 is supplied with user suppression condition data 44 corresponding with the service suppression information 32 as part of the Initial Filter Criteria (IFC). In the exemplary embodiment, trigger function 40 applies the filter criteria 42 to the incoming messages. In accordance with the exemplary embodiment, the trigger function 40 monitors the incoming messages to determine whether received communication initiation request 46, such as an INVITE request message sent from the communication initiation service 30, includes service suppression information 32 corresponding to the user suppression condition data 44 of the Initial Filter Criteria (IFC). If so, the corresponding filter criteria is triggered by trigger function 40, step 52.

The trigger function 40 operates to suppress triggering of services, step 54, and the INVITE message is not sent to an application server to execute services, such as originating or terminating services. Instead the trigger function 40 merely routes the received communication initiation request 46 onwards as communication initiation request 48.

In the exemplary embodiment the communication initiation request is routed onwards once the communication service has been suppressed, as shown in step 56 of FIG. 9, which is shown in dashed lines to indicate that this step may be omitted in some embodiments.

In one arrangement, the service suppression information 32 may be included in the communication initiation request 30 as a parameter. In particular, in the exemplary embodiment, the service suppression information 32 may be included as a parameter for a Session Initiation Protocol (SIP) Request.

In some embodiments, the service suppression information may indicate that terminating services should be suppressed for a terminating communication initiation request.

For example, application server AS(A) 24 may generate an initial SIP request with a parameter added to the Request Uniform Request Identifier URI indicating that terminating services should be suppressed for the current request.

For example, a call completion service executing on the application server AS(A) 24 may send an INVITE request to Bob containing the following request Uniform Request Identifier URI:
INVITE “bob”<sip:bob@biloxi.com>;m=BS;noifc=term SIP/2.0

### Where:

INVITE is the SIP message type used to initiate the communication session;
sip:Bob@biloxi.com is the SIP address of UE-B 2, that enables the IMS network to locate Bob;
m=BS indicates that this is a busy subscriber call completion
noifc=term is terminating service suppression information indicating that terminating services should be suppressed; and
SIP/2.0: identifies the message as a version 2.0 Session Initiation Protocol message

The noifc=term parameter added to the INVITE message request indicates that terminating services for the INVITE request message should be suppressed and should not be executed.

At the terminating Serving-Call Session Control Function S-CSCF 26 of the served user (bob@biloxi.com), the Initial Filter Criteria (IFC) used to trigger the sending of INVITE request message to the application server for the execution of the served user's terminating services, is modified.

This can be achieved in embodiments of the invention, for example by adding a condition of:

RequestURI does not match regular expression/noifc=term/to the initial filter criteria for the trigger function 40.

The addition of such a condition will result in a communication initiation message, such as an INVITE message, containing the RequestURI Initial Filter Criteria (IFC) suppression indicator (e.g. the parameter “noifc=term”) to be routed onward without invoking the application server. The terminating services will therefore be suppressed and not executed as normal.

In some embodiments, the service suppression information may indicate that originating services should be suppressed for an originating communication initiation request.

For example, application server AS(A) 24 may generate an initial SIP request with a parameter added to the Request Uniform Request Identifier URI indicating that originating services should be suppressed for the current request.

For example, a call completion service executing on the application server AS(A) 24 may send an INVITE request to Alice containing the following request Uniform Request Identifier (URI):

INVITE “Alice”<sip:alice@biloxi.com>;m=BS;noifc=orig SIP/2.0

### Where:

INVITE is the SIP message type used to initiate the communication session;
sip:Alice@biloxi.com is the SIP address of UE-B 4, that enables the IMS network to locate Alice;
m=BS indicates that this is a busy subscriber call completion
noifc=orig originating service suppression information indicating that originating services should be suppressed; and
SIP/2.0: identifies the message as a version 2.0 Session Initiation Protocol message

The noifc=orig parameter added to the communication initiation request indicates that the originating services for the communication initiation request should be suppressed and should not be executed.

At the originating Serving-Call Session Control Function S-CSCF 26 of the served user (Bob), the Initial Filter Criteria (IFC) used to trigger the sending of INVITE request message to the application server for the execution of originating services, is modified.

This can be achieved in embodiments of the invention, for example by adding a condition of:

RequestURI does not match regular expression/noifc=orig/to the initial filter criteria for the trigger function 40.

The addition of such a condition will result in a communication initiation message, such as an INVITE message, containing the RequestURI Initial Filter Criteria (IFC) suppression indicator (e.g. the parameter “noifc=orig”) to be routed onward without invoking the application server. The originating services will therefore be suppressed and not executed as normal.

In some embodiments, service suppression information for both the originating services and for the terminating services may be added to the communication initiation request. For example, in the examples given above, both originating and terminating services may be suppressed for a SIP request by adding the originating services suppression information (noifc=orig) and terminating services suppression information (noifc=term) as parameters to the Request Uniform Request Identifier (URI).

In some embodiments, the service suppression information is not added as a parameter to a SIP message, but is added as a header to the initial communication request.

Thus in some embodiments, originating service suppression information or terminating service suppression information is added to the initial SIP request as a header. Initial Filter Criteria (IFC) triggering of the originating services or the terminating services on the application server is suppressed when the incoming communication initiation request, such as an INVITE message, includes service suppression information as a header.

For example, in the terminating services suppression case the exemplary communication initiation request might have the form:
INVITE “bob”<sip:bob@biloxi.com>;m=BS SIP/2.0 IFCSuppression: term

In the originating services suppression case the exemplary communication initiation request might have the form:
INVITE “alice”<sip:alice@biloxi.com>;m=BS SIP/2.0 IFCSupression: orig

### Where:

IFC Suppression:term is an exemplary terminating service suppression header; and
IFC Suppression: orig is an exemplary originating service suppression header.

In some embodiments different parameters can be used specifying values of orig and term on a per service basis or on a per application server basis.

In either case, the information relating to the suppression of services is added to the initial communication request, and the initial communication request is sent to initiate communication.

At a network node at which the initial communication request arrives, the existence of the service suppression information is detected and the associated services are suppressed. In the exemplary illustrated embodiment this is achieved through the modification of the Initial Filter Criteria (IFC) triggers within the network.

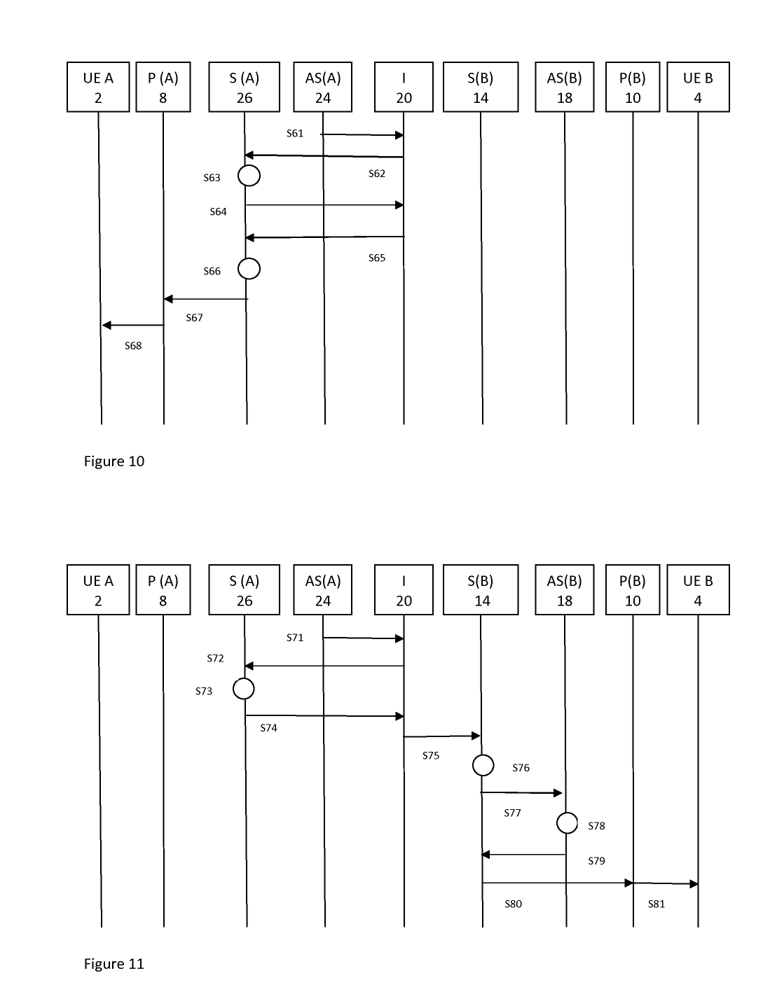

FIG. 10 shows message flows during the set up of a call leg towards the served user by a call completion service in the exemplary embodiment shown in FIG. 5.

As a first step to call completion, a call leg is set up towards Bob as the user being served by the call completion service. As will be known to a skilled person, for the call leg set up towards Bob, the initial SIP request is an INVITE request message. For this leg, both originating and terminating services are to be suppressed, since the call completion service for Bob is initiating the communication. Therefore an INVITE request message having originating services suppression information and terminating services suppression information is created and sent towards Bob.

In the exemplary embodiment, the INVITE request message has the following format:
INVITE “Bob”<sip:Bob@biloxi.com>; m=BS; noifc=orig; noifc=term SIP/2.0

### Where:

INVITE is the SIP message type used to initiate communications sessions;
sip:Bob@biloxi.com is the SIP address of UE-B 2, that enables the IMS network to locate Bob;
m=BS indicates that this is a busy subscriber call completion;
noifc=orig is originating service suppression information indicating that originating services should be suppressed;
noifc=term is terminating service suppression information indicating that terminating services should be suppressed; and
SIP/2.0: identifies the message as a version 2.0 Session Initiation Protocol message
s61. For the call leg towards the served user Bob, the call completion service on served user Bob's application server AS(A) 16 generates an INVITE message, as indicated above, to Bob. The INVITE message is sent towards the user terminal UE-A 2 for served user, Bob. This is achieved by sending the INVITE message to the Interrogating-Call Session Control Function I-CSCF 20.
s62. The Interrogating-Call Session Control Function I-CSCF 20 performs originating routing and sends the INVITE message as an originating message to Serving-Call Session Control Function S-CSCF 26 associated with Bob's user terminal UE-A 2.
s63. The INVITE message received at Serving-Call Session Control Function S-SCSF 26 is compared with Initial Filter Criteria (IFC) data relating to the first user, Bob, which the Serving-Call Session Control Function S-CSCF 26 has received from the Home Subscriber Server HSS 22. The Serving-Call Session control Function S-SCSF 26 determines whether the received INVITE message includes originating service suppression information, using the IFC data relating to the served user Bob. Since the originating services suppression information (noifc=orig) in the received INVITE message corresponds with the triggers governed by the Initial Filter Criteria (IFC) data relating to the served user, Bob, which the Serving-Call Session Control Function S-CSCF 26 has received from the Home Subscriber Server HSS 22, the originating services are suppressed. The INVITE message is not forwarded to the application server to execute the originating services for Bob.
s64. The INVITE message is now routed onwards. The Serving-Call Session Control Function S-CSCF 26 routes the INVITE message to the Interrogating-Call Session Control Function I-CSCF 20
s65. The Interrogating-Call Session Control Function I-CSCF 20 now performs terminating routing and sends the INVITE message to the Serving-Call Session Control Function S-CSCF 26 with which Bob's user terminal UE-A 2 is registered
s66. The INVITE message received at Serving-Call Session Control Function S-SCSF 26 is compared with Initial Filter Criteria (IFC) data relating to the first user, Bob, which the Serving-Call Session Control Function S-CSCF 26 has received from the HSS 22. The Serving-Call Session Control Function S-SCSF 26 determines whether the received INVITE message includes terminating service suppression information, using the Initial Filter Criteria (IFC) data relating to the served user Bob. Since the terminating services suppression information (noifc=term) in the received INVITE message corresponds with the triggers governed by the Initial Filter Criteria (IFC) data relating to the served user, Bob, which the S-CSCF 26 has received from the HSS 22, the terminating services are suppressed. The INVITE message is not forwarded to the application server to execute the terminating services for Bob.
s67. Serving-Call Session Control Function S-CSCF 26 then sends the INVITE message to the Proxy- Call Session Control Function P-CSCF 8 with which Bob's user terminal UE-A 2 is registered
s68. The Proxy- Call Session Control Function P-CSCF 8 removes the service suppression information (noifc=orig and noifc=term) and sends the INVITE message on to Bob's user terminal UE-A 2.

In this way, the call leg towards the served user Bob is established and no further triggering of originating or terminating services occurs.

Once the call leg is established towards Bob as the user being served by the call completion service, the call leg to the called user Alice is set up. For this leg, originating services are to be suppressed for Bob, but the terminating services do need to be executed for Alice. Therefore an INVITE request message having originating services suppression information is created and sent towards Alice. The INVITE request message has the following format:
INVITE “Alice”<sip:Alice@biloxi.com>; m=BS; noifc=orig; SIP/2.0

### Where:

INVITE is the SIP message type used to initiate communications sessions;
sip:Alice@biloxi.com is the SIP address of UE-B 4, that enables the IMS network to locate Alice;
m=BS indicates that this is a busy subscriber call completion;
noifc=orig is originating service suppression information indicating that originating services should be suppressed; and
SIP/2.0: identifies the message as a version 2.0 Session Initiation Protocol message

FIG. 11 shows message flows during the set up of a call leg towards the served user in the communications network 500 shown in FIG. 5.
S71. For the call leg towards the called user Alice, the call completion service on served user Bob's application server AS(A) 16 generates an INVITE message, as indicated above, to Alice. The INVITE message is sent towards the user terminal UE-B 4 for the called user, Alice. This is achieved by sending the INVITE message to the Interrogating-Call Session Control Function I-CSCF 20.
S72. The Interrogating-Call Session Control Function I-CSCF 20 performs originating routing and sends the INVITE message to Serving-Call Session Control Function S-CSCF 26 associated with Bob's user terminal UE-A 2
S73. The INVITE message received at Serving-Call Session Control Function S-SCSF 26 is compared with Initial Filter Criteria (IFC) data relating to the first user, Bob, which the Serving-Call Session Control Function S-CSCF 26 has received from the Home Subscriber Server HSS 22. The Serving-Call Session Control Function S-SCSF 26 determines whether the received INVITE message includes originating service suppression information, using the Initial Filter Criteria (IFC) data relating to the served user Bob. Since the originating services suppression information (noifc=orig) in the received INVITE message corresponds with the triggers governed by the Initial Filter Criteria (IFC) data relating to the served user, Bob, which the Serving-Call Session Control Function S-CSCF 26 has received from the Home Subscriber Server HSS 22, the originating services are suppressed. The INVITE message is not forwarded to the application server to execute the originating services for Bob.
S74. The INVITE message is now routed onwards. The Serving-Call Session Control Function S-CSCF 26 routes the INVITE message to the Interrogating-Call Session Control Function I-CSCF 20
S75. The Interrogating-Call Session Control Function I-CSCF 20 now performs terminating routing and sends the INVITE message to the Serving-Call Session Control Function S-CSCF 14 with which Alice's user terminal UE-B 4 is registered.
S76. The INVITE message received at Serving-Call Session Control Function S-SCSF 14 with terminating routing is compared with Initial Filter Criteria (IFC) data relating to the called user, Alice, which the Serving-Call Session Control Function S-CSCF 14 has received from the Home Subscriber Server HSS 22. An Initial Filter Criteria (IFC) trigger for execution of terminating services is satisfied by the received INVITE message, which identifies the application server AS(B) 18 providing terminating services for Alice.
S77. In response to the terminating Initial Filter Criteria (IFC) triggering, the Serving-Call Session Control Function S-CSCF 14 sends the INVITE message to the identified application server AS(B) 18.
S78. Application server AS(B) 18 executes the terminating services for Alice.
S79. Once terminating services have been executed, the application server AS(B) 18 sends the INVITE message back to the Serving-Call Session Control Function S-CSCF 14 that Alice is registered with.
S80. Serving-Call Session Control Function S-CSCF 14 then sends the INVITE message to the Proxy-Call Session Control Function P-CSCF 10 with which Alice's user terminal UE-B 4 is registered
S81. The Proxy-Call Session Control Function P-CSCF 10 sends the INVITE to Alice's user terminal UE-B 4.

From a consideration of the above description and the accompanying drawings, it can be seen that the suppression of both originating and terminating services for Bob during the set up of the call leg towards the served user Bob and the suppression of the originating services for Bob but not the terminating services for Alice during set up of the call leg towards the called user Alice, results in the correct services being executed for both Bob and Alice.

Embodiments can be used in any situation where there is a requirement to suppress services at an application server for any SIP request generated by a network node such as an application server. In particular, embodiments may be used to suppress Initial Filter Criteria (IFC) triggering of originating and/or terminating services on application servers.

Further service suppression parameters having different names that are distinct from each other may be introduced on a per service basis or on a per application server basis, if it is required to suppress the triggering of different application servers depending on the service type for the purpose of handling feature interactions.

In a further exemplary embodiment, the service is suppressed only in part. In this further exemplary embodiment, the communication initiation request reaches the application server, but the service suppression information causes the application server to execute only part of the service, and to suppress a part of the service.

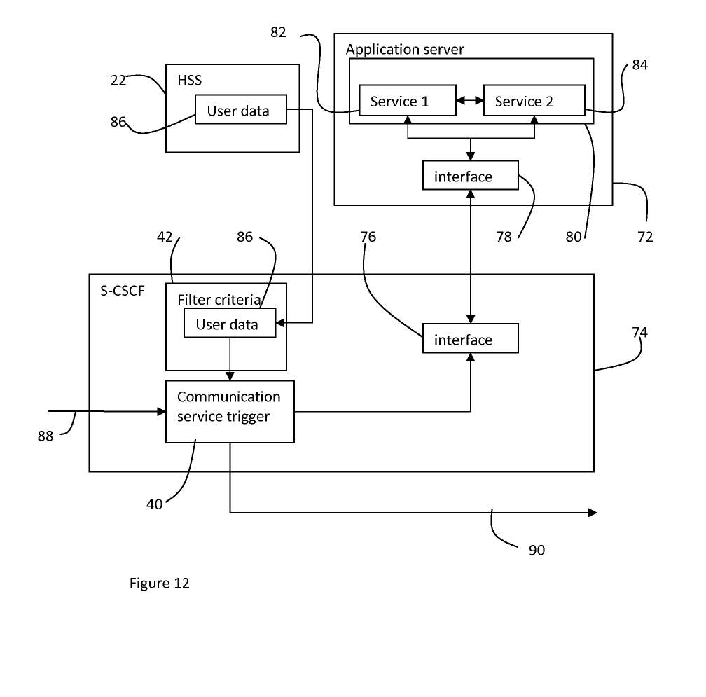

FIG. 12 shows a block diagram of the main components of a network node of the call session signalling system of the communications network 500 shown in FIG. 5 in accordance with a second embodiment.

FIG. 13 is a flow chart showing steps in a method of initiating communication in a network node shown in FIG. 12.

FIG. 12 shows an application server 72 and a Serving Call Session Control Function S-CSCF 74 of a second exemplary embodiment.

In some arrangements, the application server 72 and a Serving Call Session Control Function S-CSCF 74 of the second exemplary embodiment may replace the application server 18 and the S-CSCF 14 of FIG. 5.

The Serving-Call Session Control Function S-CSCF 26 of FIG. 5 operates in a second operating mode in accordance with the described exemplary embodiment, and only components relevant to the operation in accordance with the second operating mode have been shown.

The Serving-Call Session Control Function S-CSCF 74 has a trigger function 40 coupled to a filter criteria store 42 in which user data 86 is stored. The user data 86 stored in the filter criteria 42 of the Serving-Call Session Control Function S-CSCF 26 is downloaded from the Home Subscriber Server HSS 22. In the exemplary embodiment the user data 86 comprises Initial Filter Criteria (IFC). The Serving-Call Session

Control Function S-CSCF 74 also has an interface 76 for sending messages to application server 72, and for receiving messages from application server 72. In the exemplary embodiment, the messages are Session Initiation Protocol (SIP) messages.

Application server 72 has an interface 78 for communicating with the interface 76 of the Serving-Call Session Control Function S-CSCF 74. The application server has application logic 80 for controlling and running a plurality of services. A first sub-service 82 and a second sub-service 84 are provided. The first sub-service 82 and a second sub-service 84 are separately executable by the application logic, but together the first sub-service 82 and a second sub-service 84 form a single service.

A flow chart of a method of initiating communication in the arrangement shown in FIG. 12 in accordance with an exemplary embodiment is shown in FIG. 13. In this embodiment, the communication service is suppressed only in part. In the exemplary embodiment, only the first sub-service 82 of the service is suppressed and the second sub-service is executed by the application logic 80.

The operation of the Serving Call Session Control Function S-CSCF 76 is shown in dashed lines corresponds to the conventional operation of the Serving Call Session Control Function S-CSCF 76. Thus, in a first step 58 a communication initiation message is received by Serving Call Session Control Function S-CSCF 76 and in step 60 the Serving Call Session Control Function S-CSCF 76 determines whether the communication initiation request is to be routed to the application server 72. If so, the communication initiation request is routed to the application server in step 62.

In the exemplary embodiment shown in FIG. 12, the trigger function 40 examines the received communication initiation request to see whether an initial filter criteria IFC is triggered, for example a trigger for the execution of originating services in step 60. If so, the communication initiation request is forwarded to the application server 72 to execute the services.

The application server 72 receives the communication initiation request in step 64. In step 66 the application logic 80 determines whether service suppression information is included in the received communication initiation request. If so, in step 68 a first sub-service 82 is suppressed, but the second sub-service 84 is executed. Thus the service comprising first sub-service 82 and second sub-service 84 is partially suppressed.

Finally, in some arrangements, the communication initiation request is routed back to the Serving Call Session Control Function S-CSCF 76, step 70. Step 70 is shown in dashed lined since it may be omitted in some arrangements.

In the first exemplary arrangement, the modified initial filter criteria IFC used by a Serving Call Session Control Function S-CSCF 76 triggered by service suppression information in a received communication initiation request for a particular user causes the routing of the communication initiation request to the application server, and therefore the services executed thereby, to be suppressed.

In the second exemplary arrangement, the initial filter criteria IFC used by a Serving Call Session Control Function S-CSCF 76 triggered by a received communication initiation request for a particular user causes the routing of the communication initiation request to the application server, and the application logic suppresses part of the service in response to the service suppression information in the communication initiation request.

Embodiments allow a service within a network node, such as an application server, to generate a communication request message that can offer a level of control of the triggering of services on another application server in whole or in part, thus giving more control of feature interaction.

A 3PCC mechanism is a general mechanism used for initiating sessions from a network node and communication completion is therefore cited as an example service in this invention. The invention could also be used to solve similar problems for other services that employ 3PCC procedures and for other SIP requests that are generated by an application server.

In the described exemplary embodiment the communication initiation request is a Session Initiation Protocol request, and in particular is a Session Initiation Protocol INVITE request. However in different embodiments of the invention other types of communication initiation requests can be used.

In the described exemplary embodiment the comparison of user data with information in the communication initiation request is achieved using Initial Filter Criteria (IFC) triggering. The Initial Filter Criteria (IFC) suppression information could be configured by the network operator or it could comprise fixed values that are applied in the application server in different embodiments.

The present invention advantageously allows a service within the application server to generate a request that offers a control of triggering of other services and/or application servers, thus giving more control of feature interaction.

Modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. (canceled)

2. (canceled)

3. (canceled)

4. (canceled)

5. A method in a network node of a communications network, comprising:
receiving a communication initiation request;
determining whether the communication initiation request includes service suppression information indicating that a part of a communication service associated with the communication should be suppressed; and
suppressing the part of a communication service corresponding to the service suppression information when the communication initiation request includes service suppression information.

6. The method as claimed in claim 5 where the communication initiation request comprises an initial Session Initiation Protocol request message.

7. The method as claimed in claim 5 where originating service suppression information indicates that Initial Filter Criteria triggering of originating services should be suppressed as the request is routed through a network. .

8. The method as claimed in claim 7 wherein determining whether the communication initiation request includes the service suppression information comprises applying a modified originating Initial Filter Criteria trigger to a received initial Session Initiation Protocol message in an IP multimedia subsystem network, the originating Initial Filter Criteria trigger being such that the triggering of originating services is suppressed if originating service suppression information is received.

9. The method as claimed in claim 5 where terminating service suppression information indicates that Initial Filter Criteria triggering of terminating services should be suppressed as the request is routed through a network.

10. The method as claimed in claim 9 wherein determining whether the communication initiation request includes the service suppression information comprises applying modified terminating Initial Filter Criteria trigger to a received initial Session Initiation Protocol message in an IP multimedia subsystem network, the terminating Initial Filter Criteria triggers being such that the triggering of terminating services is suppressed if terminating service suppression information is received.

11. The method as claimed in claim 5 wherein determining whether the communication initiation request includes the service suppression information results in a positive determination if service suppression information corresponding to user suppression condition data at the network node is included in the communication initiation request.

12. The method as claimed in claim 11 wherein the user suppression condition data comprise filter criteria within a Session Initiation Protocol network.

13. The method as claimed in claim 11 further comprising obtaining user suppression condition data relating to a user from a user data store.

14. The method as claimed in claim 5 in which suppressing communication services comprises routing a communication initiation request without invoking a communication service identified by the service suppression information.

15. The method as claimed in claim 5 wherein suppressing at least a part of the communication service, comprising at least a first sub-service and a second sub-service, comprises suppressing the invoking of at least the first sub-service when a received communication initiation request includes service suppression information.

16. The method as claimed in claim 5 wherein service suppression information is included in a header of the communication initiation request.

17. The method as claimed in claim 5 wherein service suppression information is included as a parameter of the communication initiation request.

18. (canceled)

19. A network node for a communications network comprising:
communication initiation service element, for generating a communication initiation request, the communication initiation request including service suppression information indicating that a part of a communication service associated with the communication should be suppressed; and
interface for sending the communication initiation request to establish communication.

20. A network node for a communications network comprising:
communication service trigger element arranged to receive a communication initiation request and to determine whether the received communication initiation request includes service suppression information indicating that a part of a communication service associated with the communication should be suppressed; and for suppressing the part of a communication service corresponding to the service suppression information when the communication initiation request includes service suppression information.

21. The network node as claimed in claim 20 further comprises:
a store for storing user suppression condition data, the store being coupled to the communication service trigger element to supply the user suppression condition data to the communication service trigger element,
wherein the communication service trigger element determines that the received communication initiation request includes service suppression information if service suppression information corresponding to user suppression condition data is included in the communication initiation request.

22. The network node as claimed in claim 20 comprising:
a first service element, for providing a first communication sub-service;
a second service element, for providing a second communication sub-service;
the communication service trigger element being operable to execute at least the first service element and the second service element to provide a communication service, wherein the communication service trigger element suppresses the execution of at least the first service element when a received communication initiation request includes service suppression information.

23. (canceled)

24. (canceled)
